(19) United States
(12) Patent Application Publication
(10) Pub. No.: US 2012/0147228 A1
(43) Pub. Date: Jun. 14, 2012

(54) IMAGING SYSTEMS WITH OPTICAL CROSSTALK SUPPRESSION STRUCTURES

(76) Inventors: Jacques Duparré, Jena (DE); Ulrich Boettiger, Boise, ID (US)

(21) Appl. No.: 12/968,076

(22) Filed: Dec. 14, 2010

(51) Int. Cl. H04N 9/097

(52) U.S. Cl. 348/262; 348/E09.008

(57) ABSTRACT

An imaging system may include an image sensor and lenses on a substrate. The lenses may focus light onto the image sensor. The imaging system may include multiple optical channels, each of which directs light at a particular wavelength or range of wavelengths to a particular region of the image sensor. The imaging system may include optical crosstalk suppression structures that reduce or minimize optical crosstalk between the optical channels. The optical crosstalk suppression structures may include, for each optical channel, at least a pair of matching color filters. The color filters may keep any light that leaks between optical channels from reaching the image sensor.

### BACKGROUND

This relates to imaging systems and, more particularly, to imaging systems with optical crosstalk suppression structures.

Modern electronic devices such as cellular telephones, cameras, and computers often use digital image sensors. Imagers (i.e., image sensors) may be formed from a two-dimensional array of image sensing pixels. Each pixel receives incident photons (light) and converts the photons into electrical signals. Image sensors are sometimes designed to provide images to electronic devices using a Joint Photographic Experts Group (JPEG) format.

Some conventional imaging systems include multiple optical channels, each of which is optimized for a different frequency or range of frequencies. As an example, some imaging systems include a red channel, a green channel, and a blue channel. Each optical channel includes a lens that focuses light onto one or more image sensing pixels associated with that optical channel. In order to maintain optical separation between the various channels, conventional imaging systems include vertical baffles that provide optical channel separation between the various optical channels.

In certain situations, imaging systems have lenses that are formed on glass substrates. However, vertical baffles, which are the conventional means of crosstalk suppression, cannot easily be implemented within glass substrates. Therefore, conventional crosstalk suppression structures (e.g., vertical baffles) may provide inadequate crosstalk suppression in imaging systems with glass substrates.

It would therefore be desirable to provide imaging systems with optical crosstalk suppression structures.

### BRIEF DESCRIPTION OF THE DRAWINGS

FIG. 1 is a diagram of an illustrative electronic device that may include a camera sensor having optical crosstalk suppression in accordance with an embodiment of the present invention.

FIG. 2 is a diagram of a conventional imaging system that includes vertical baffles that provide optical crosstalk suppression between multiple optical channels.

FIG. 3 is a top view of the vertical baffles of the conventional imaging system of FIG. 3.

FIG. 4 is a diagram of a conventional imaging system that includes lenses on a glass substrate and vertical baffles that provide optical crosstalk suppression between multiple optical channels.

FIG. 5 is a diagram of an illustrative camera module such as the camera module of FIG. 1 that may include lenses on a substrate and optical crosstalk suppression structures such as color filters in accordance with an embodiment of the present invention.

### DETAILED DESCRIPTION

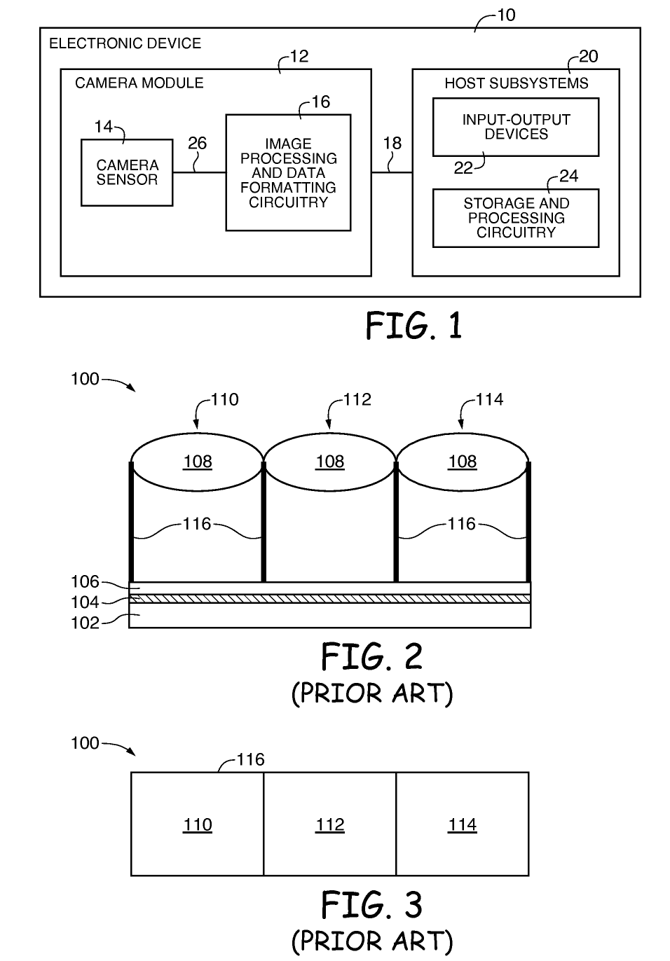

An electronic device with a digital camera module is shown in FIG. 1. Electronic device 10 may be a digital camera, a computer, a cellular telephone, a medical device, or other electronic device. Camera module 12 may include image sensor 14 and one or more lenses. During operation, the lenses focus light onto image sensor 14. Image sensor 14 includes photosensitive elements (i.e., pixels) that convert the light into digital data. Image sensors may have any number of pixels (e.g., hundreds, thousands, millions, or more). A typical image sensor may, for example, have millions of pixels (e.g., megapixels). As examples, image sensor 14 may include address circuitry, analog-to-digital (ADC) converter circuitry amplifier circuitry, switching circuitry (e.g., randomizing switching circuitry), data output circuitry, sample-and-hold circuitry, correlated double sampling (CDS) circuitry, memory (e.g., buffer circuitry), bias circuitry (e.g., source follower load circuits), etc.

Still and video image data from camera sensor 14 may be provided to image processing and data formatting circuitry 16 via path 26. Image processing and data formatting circuitry 16 may be used to perform image processing functions such as data formatting, adjusting white balance and exposure, implementing video image stabilization, face detection, etc. Image processing and data formatting circuitry 16 may also be used to compress raw camera image files if desired (e.g., to Joint Photographic Experts Group or JPEG format). In a typical arrangement, which is sometimes referred to as a system on chip or SOC arrangement, camera sensor 14 and image processing and data formatting circuitry 16 are implemented on a common integrated circuit. The use of a single integrated circuit to implement camera sensor 14 and image processing and data formatting circuitry 16 can help to minimize costs.

Camera module 12 (e.g., image processing and data formatting circuitry 16) conveys acquired image data to host subsystem 20 over path 18. Electronic device 10 typically provides a user with numerous high-level functions. In a computer or advanced cellular telephone, for example, a user may be provided with the ability to run user applications. To implement these functions, host subsystem 20 of electronic device 10 may have input-output devices 22 such as keypads, input-output ports, joysticks, and displays and storage and processing circuitry 24. Storage and processing circuitry 24 may include volatile and nonvolatile memory (e.g., random-access memory, flash memory, hard drives, solid state drives, etc.). Storage and processing circuitry 24 may also include microprocessors, microcontrollers, digital signal processors, application specific integrated circuits, etc.

As shown in FIG. 2, conventional imaging system 100 includes CMOS image sensor 102 (e.g., an array of image sensing pixels), color filters 104, microlenses 106 (e.g., an array of microlenses, each of which focuses light onto one or more imaging sensing pixels), lenses 108, and vertical baffles 116. Vertical baffles 116 suppress optical crosstalk (i.e., light leakage) between optical channels 110, 112, and 114. Each of the optical channels 110, 112, and 114 is optimized for a different frequency or a different range of frequencies. In the example of FIG. 2, channel 110 is a red channel, optical channel 112 is a green channel, and optical channel 114 is a blue channel.

Vertical baffles 116 typically surround optical channels 110, 112, and 114, to prevent light leaking from within one of the optical channels into an adjacent optical channel. A top view of conventional imaging system 100 of FIG. 2 which illustrates how vertical baffles 116 surround optical channels 110, 112, and 114 is shown in FIG. 3.

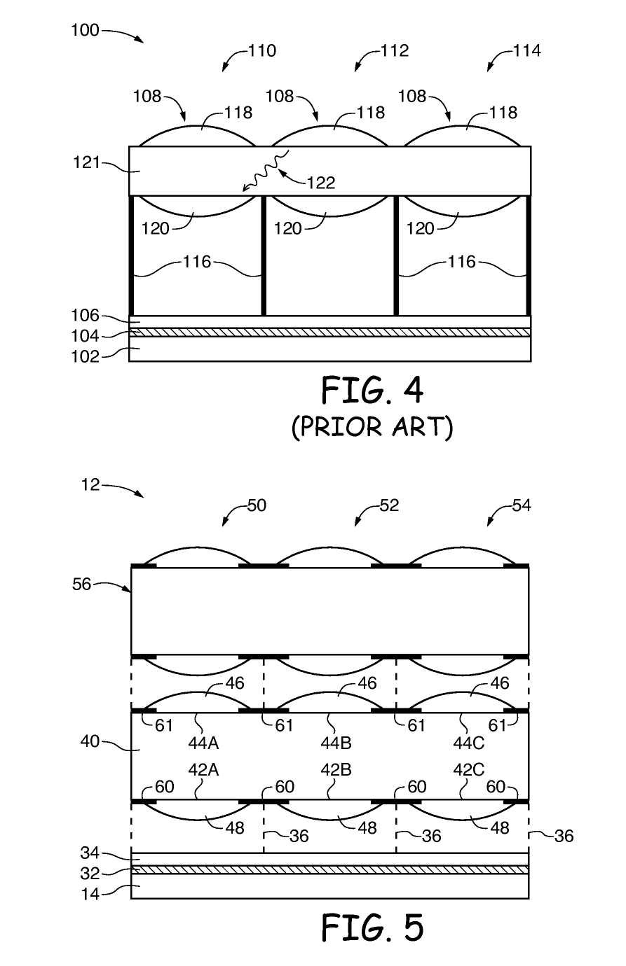

In certain situations, lenses 108 of imaging system 100 are formed on glass substrates, as shown in FIG. 4. In the example of FIG. 4, lenses 108 are formed from upper lenses 118 and lower lenses 120 on glass substrate 121. Because the vertical baffles 116 do not extend into glass substrate 121, light can leak between optical channels 110, 112, and 114, as illustrated by photon 122 which is leaking from the upper lens 118 associated with channel 112 to the lower lens 120 associated with channel 110. As the thickness of glass substrate 121 increases, the optical crosstalk (i.e., light leakage) between channels 110, 112, and 114 also increases.

Camera sensor 12 of FIG. 1 may include optical crosstalk suppression structures such as matched color filters (e.g., stacked color filters, pairs of color filters, sets of color filters, etc.), which do not have the limitations of conventional vertical baffles. The optical crosstalk suppression structures of camera sensor 12 may provide optical crosstalk suppression even when camera sensor 12 includes a substrate in which vertical baffles are not formed (e.g., a glass substrate). An arrangement of this type is shown in FIG. 5.

As shown in FIG. 5, camera sensor 12 may include an image sensor 14 (e.g., an array of image sensing pixels), an optional layer of color filters 32, an optional layer of microlenses 34 (e.g., lenses 34 that focus light onto one or more image sensing pixels), standoffs 36 (e.g., structures that hold substrate 40 in place above image sensor 14), a substrate 40 (e.g., a substrate formed from glass, plastic, or other optically transparent material), apertures 60 and 61 (e.g., light blocking structures with openings for lenses 46 and 48 and color filters 42 and 44), lenses 46 and 48 which may be formed on apertures 60 and 61, and optional color filters 42 and 44. Apertures 60 and 61 may be provided to ensure that light passing through substrate 40 passes through filters 42 (if filters 42 are present), passes through filters 44 (if filters 44 are present), passes through lenses 46 (if lenses 46 are present), and passes through lenses 48 (if lenses 48 are present). Apertures 60 may have portions that form openings for lenses 48 and apertures 61 may have portions that form openings for lenses 46. The openings in apertures 60 may be smaller than, larger than, or approximately the same size as the openings in apertures 61 (e.g., the openings in apertures 60 may have diameters that are smaller than, larger than, or approximately the same as the diameters of the openings in apertures 61).

Stacked color filters (e.g., matched color filters) in camera sensor 12 such as color filters 32, 42, and 44 may form optical crosstalk suppression structures. The optical crosstalk suppression structures in camera sensor 12 may form isolated optical channels such as channels 50, 52, and 54. Optical channels 50, 52, and 54 may include, as examples, visible light channels such as red, green, and blue channels, infrared light channels, and ultraviolet light channels. As another example, camera sensor 12 may implement a CMY color model and may include optical channels in camera sensor 12 such as a cyan optical channel, a magenta optical channel, and a yellow optical channel (and, optionally, a black and white optical channel). As one example, camera sensor 12 may include some combination of visible light optical channels, infrared light optical channels, and ultraviolet optical channels. While the example of FIG. 5 illustrates camera module 12 as having three optical channels, in general camera module 12 may have any number of optical channels (e.g., camera module 12 may have two optical channels, three optical channels, four optical channels, five optical channels, more than five optical channels, etc.). With one suitable arrangement, optical channel 50 may be a red optical channel that conveys red light to imaging pixels that are sensitive to red light, optical channel 52 may be a green optical channel that conveys green light to imaging pixels that are sensitive to green light, and optical channel 54 may be a blue optical channel that conveys blue light to imaging pixels that are sensitive to blue light.

In order to form optical channels such as optical channels 50, 52, and 54 of FIG. 5 and to provide optical crosstalk suppression between the optical channels, camera module 12 may include at least a pair of color filters of roughly the same spectral transmission in each optical channel. If desired, camera module 12 may include multiple matched sets of color filters. Each set of matched color filters may be associated with an optical channel and may include at least two color filters of roughly the same spectral transmission. The spectral transmissions of color filters in each optical channel may be different than the spectral transmissions of color filters in neighboring optical channels. As examples, camera module 12 may include color filters 32, 42, and 44; color filters 42 and 44; color filters 32 and 42; or color filters 32 and 44.

Color filters 32, 42, and 44 may, if desired, have relatively sharp transmission curves (e.g., red filters 42A and 44A may have a high transmission for red light and a low transmission for green and blue light, green filters 42B and 44B may have a high transmission for green light and a low transmission for red and blue light, and blue filters 42C and 44C may have a high transmission for blue light and a low transmission for red and green light). If desired, the two or more color filters in each optical channel may have different transmission curves. For example, red filter 42A may have a transmission curve that varies from red filter 44A, although both filters 42A and 44A may primarily pass red light.

As one example, camera module 12 may include color filters 42 and 44. With arrangements of this type, color filters 42A and 44A may be red color filters (when optical channel 50 is a red optical channel), color filters 42B and 44B may be green color filters (when optical channel 52 is a green optical channel), and color filters 42C and 44C may be blue color filters (when optical channel 54 is a blue optical channel). The pair of matched color filters in each optical channel may suppress any optical crosstalk that occurs between channels 50, 52, and 54. For example, if light from channel 52 passes through filter 44B and then leaks into channel 50, the light would be blocked by filter 42A before reaching the imaging pixels that are associated with channel 50, because filter 42A may only transmit light at frequencies that are different from the light that filter 44B transmits.

If desired, camera module 12 may or may not include color filters 32 in arrangements in which camera module 12 includes color filters 42 and 44. If camera module 12 does include color filters 32 in arrangement of this type, the color filters 32 associated with optical channel 50 may transmit light at frequencies similar to the frequencies of light transmitted by filters 42A and 44A, the color filters 32 associated with optical channel 52 may transmit light at frequencies similar to the frequencies of light transmitted by filters 42B and 44B, and the color filters 32 associated with optical channel 54 may transmit light at frequencies similar to the frequencies of light transmitted by filters 42C and 44C.

As another example, camera module 12 may include color filters 32 and color filters 44. With arrangements of this type, the color filters 32 associated with optical channel 50 and color filters 44A may be red color filters (when optical channel 50 is a red optical channel), the color filters 32 associated with optical channel 52 and color filters 44B may be green color filters (when optical channel 52 is a green optical channel), and the color filters 32 associated with optical channel 54 and color filters 44C may be blue color filters (when optical channel 54 is a blue optical channel). As with the other examples described above in connection with FIG. 5, arrangements of this type provide optical crosstalk suppression between the optical channels in camera module 12. For example, if light from channel 52 passes through filter 44B and then leaks into channel 50, the light would be blocked by the filters 32 associated with channel 50 before reaching the imaging pixels that are associated with channel 50, because the filters 32 associated with channel 50 may only transmit light at frequencies that are different from the light that filter 44B transmits.

As shown in FIG. 5, camera module 12 may include two or more substrate layers that are stacked together. For example, camera module 12 may include a first substrate layer such as substrate 40 and a second substrate layer such as substrate 56 stacked upon substrate 40. In general, camera module 12 may include any number of substrate layers. As with substrate 40, additional substrates in camera module 12 such as substrate 56 may include (as shown in FIG. 5) lenses such as lenses 46 and 48, color filters such as color filters 42 and 44, and standoffs such as standoffs 36. In arrangements in which camera module 12 includes more than one substrate layer, each optical channel may include at least a pair of matching color filters. If desired, the axial separation between the at least two matching color filters in each optical channel may be maximized (in order to minimize or reduce crosstalk). For example, camera module 12 may include color filters 32 adjacent to image sensor 14 and color filters 44A on the outermost substrate (e.g., substrate 40 if camera module 12 includes only a single substrate layer, substrate 56 if camera module 12 includes two substrate layers, etc.).

Various embodiments have been described illustrating imaging systems with optical crosstalk suppression structures.

An electronic device may have a camera module with an image sensor array that captures images, one or more optically transparent substrates, lenses on the substrate that focus light onto the image sensor array, and optical crosstalk suppression structures such as matching color filters. The camera module may include multiple optical channels, each of which directs light at a particular wavelength or range of wavelengths to a particular region of the image sensor. As one example, the camera module may include a red optical channel, a green optical channel, and a blue optical channel. As other examples, the camera module may include any combination of a red optical channel, a green optical channel, a blue optical channel, a visible light optical channel, an infrared optical channel, an ultraviolet optical channel, etc.

Each optical channel may include at least a pair of matching color filters. By filtering light at two or more locations within each optical channel, any light that manages to leak between optical channels may be filtered out by subsequent color filters.

The foregoing is merely illustrative of the principles of this invention which can be practiced in other embodiments.

What is claimed is:

1. An imaging system comprising:
first and second optical channels;
first and second color filters that are a part of the first optical channel and that transmit light at a first frequency; and
third and fourth color filters that are a part of the second optical channel and that transmit light at a second frequency that is different from the first frequency.

2. The imaging system defined in claim 1 further comprising:
a substrate, wherein the first and second optical channels pass through the substrate and wherein the substrate is substantially transparent to light;
a first lens that is a part of the first optical channel; and
a second lens that is a part of the second optical channel.

3. The imaging system defined in claim 1 further comprising:
a substrate, wherein the first and second optical channels pass through the substrate and wherein the substrate is substantially transparent to light;
first and second lenses that are a part of the first optical channel, wherein the first lens is formed on a first side of the substrate and wherein the second lens is formed on a second side of the substrate that is opposite the first side of the substrate; and
third and fourth lenses that are a part of the second optical channel, wherein the third lens is formed on the first side of the substrate and wherein the fourth lens is formed on the second side of the substrate.

4. The imaging system defined in claim 3 further comprising:
light blocking structures on the first and second sides of the substrate, wherein the light blocking structures have portions defining openings, wherein the first, second, third, and fourth lenses are formed within the openings in the light blocking structures on the substrate, and wherein the first and third color filters are formed on the first side of the substrate.

5. The imaging system defined in claim 4 wherein the second and fourth color filters are formed on the second side of the substrate.

6. The imaging system defined in claim 4 wherein the second color filter is formed above a first set of the image sensing pixels and wherein the fourth color filter is formed above a second set of the image sensing pixels.

7. The imaging system defined in claim 4 wherein the substrate is a first substrate, the imaging system further comprising a second substrate, wherein the second and fourth color filters are formed on the second substrate.

8. The imaging system defined in claim 1 further comprising:
a plurality of image sensing pixels, wherein some of the image sensing pixels receive light that passes through the first optical channel and wherein some of the image sensing pixels receive light that passes through the second optical channel.

9. The imaging system defined in claim 8 further comprising:
a layer of microlenses above the plurality of image sensing pixels, wherein each of the microlenses focuses light onto a single one of the image sensing pixels.

10. The imaging system defined in claim 8 further comprising:
at least one standoff structure that is physically connected to the plurality of image sensing pixels.

11. The imaging system defined in claim 1 wherein the first optical channel is an optical channel selected from the group consisting of: a red optical channel that conveys red light, a green optical channel that conveys green light, a blue optical channel that conveys blue light, an infrared optical channel that conveys infrared light, an ultraviolet optical channel that conveys ultraviolet light, a cyan optical channel that conveys cyan light, a magenta optical channel that conveys magenta light, and a yellow optical channel that conveys yellow light.

12. An imaging system comprising:
a plurality of image sensing pixels that lie in a first plane;
first and second color filters that transmit light at a first frequency; and
third and fourth color filters that transmit light at a second frequency that is different from the first frequency, wherein the first and third color filters lie in a second plane that is substantially parallel to the first plane and wherein the second and fourth color filters lie in a third plane that is between the first and second planes and that is substantially parallel to the first plane.

13. The imaging system defined in claim 12 further comprising:
a substrate;
a first lens that is formed on the substrate and that focuses light onto a first set of the image sensing pixels; and
a second lens that is formed on the substrate and that focuses light onto a second set of the image sensing pixels.

14. The imaging system defined in claim 13, wherein the first and third color filters are formed on a first side of the substrate.

15. The imaging system defined in claim 14 wherein the second and fourth color filters are formed on a second side of the substrate that is opposite the first side of the substrate.

16. The imaging system defined in claim 14 wherein the second color filter is formed above the image sensing pixels in the first set of the image sensing pixels and wherein the fourth color filter is formed above the image sensing pixels in the second set of the image sensing pixels.

17. The imaging system defined in claim 12 further comprising:
first and second substrates, wherein the first and third color filters are formed on the first substrate and wherein the second and fourth color filters are formed on the second substrate.

18. An imaging system comprising:
a plurality of image sensing pixels that lie in a first plane;
a substrate, wherein there are first and second optical channels that pass through the substrate to the image sensing pixels;
a first lens that is a part of the first optical channel, that is formed on the substrate, that focuses light onto a first set of the image sensing pixels, and that lies in a second plane;
a second lens that is a part of the second optical channel, that is formed on the substrate, that focuses light onto at a second set of the image sensing pixels, and that lies in the second plane;
first and second color filters that are a part of the first optical channel and that transmit light at a first frequency; and
third and fourth color filters that are a part of the second optical channel and that transmit light at a second frequency that is different from the first frequency, wherein the first and third color filters lie in a third plane that is substantially parallel to the first plane and wherein the second and fourth color filters lie in a fourth plane that is between the first and third planes and that is substantially parallel to the first plane.

19. The imaging system defined in claim 18 wherein the first and third color filters are formed on a first side of the substrate.

20. The imaging system defined in claim 19 wherein the second and fourth color filters are formed on a second side of the substrate that is opposite the first side of the substrate.

21. The imaging system defined in claim 20 further comprising:
a fifth color filter, wherein the fifth color filter transmits light at the first frequency and is a part of the first optical channel; and
a sixth color filter, wherein the sixth color filter transmits light at the second frequency and is a part of the second optical channel.

22. The imaging system defined in claim 21 wherein the fifth color filter is formed above the first set of image sensing pixels and wherein the sixth color filter is formed above the second set of image sensing pixels.
